(19) United States
(12) Patent Application Publication
(10) Pub. No.: US 2026/0222811 A1
(43) Pub. Date: Jul. 30, 2026

(54) Silent Multi-Factor Authentication

(71) Applicant: Telefonaktiebolaget LM Ericsson (publ), Stockholm (SE)

(72) Inventors: Mikael Klein, Huddinge (SE); Patrik Teppo, Bobäck (FI); Kazi Wali Ullah, Espoo (FI)

(21) Appl. No.: 19/148,816

(22) PCT Filed: Jan. 23, 2023
(86) PCT No.: PCT/EP2023/051553

§ 371 Date: Jul. 17, 2025

(51) Int. Cl. H04W 12/062; H04W 12/72

(52) U.S. Cl. CPC H04W 12/062; H04W 12/72

(57) ABSTRACT

A domain name system, DNS, server (21) in a communication network (10) facilitates silent multi-factor authentication of a user (12U) of an application (12A). The DNS server (21) receives, from a communication device (12) on which the application (12A) executes, a DNS query (28) requesting the DNS server (21) to resolve a domain name (26) that is generic for some second factor server of some communication network. The DNS server (21) resolves the domain name (26) into an address (20A) of a second factor server (20) in the communication network (10) that is configured to generate a second factor (F2) for authenticating the user (12U) of the application (12A). The DNS server (21) transmits, to the communication device (12), a DNS response (30) that indicates the address (20A) of the second factor server (20) in the communication network (10).

### TECHNICAL FIELD

The present application relates generally to authentication of a user of an application, and relates more particularly to silent multi-factor authentication of such a user.

### BACKGROUND

Multi-factor authentication strengthens access security by requiring multiple factors for authenticating a user of an application. Two-factor authentication may for example require the user to authenticate himself or herself to the application using a both first factor in the form of something the user knows (e.g., a username and password/PIN) and a second factor in the form of something the user has or is (e.g., an email address, phone number, or a fingerprint). Although multi-factor authentication mitigates fraud, phishing, account takeover, and other security vulnerabilities, it threatens to jeopardize the user experience by introducing additional delay and obstacles to access.

Silent multi-factor authentication aims to preserve the multi-factor nature of user authentication while eliminating or reducing the burden on the user, e.g., so that the multi-factor nature of the authentication is transparent or ‘silent’ to the user. Challenges exist, though, in realizing silent multi-factor authentication. Some known approaches to silent multi-factor authentication, such as Global System for Mobile communications Association (GSMA) Mobile Connect, exploit subscription credentials that the user's communication device uses to access a communication network, as a basis for the second factor of authentication. Problematically, though, these approaches undesirably introduce additional burdens on application providers to individually configure multi-factor authentication for different communication networks. Furthermore, some approaches prove problematic on certain types of devices that have restricted application programming interfaces (APIs), e.g., restricting access of the application to lower-level communication network details.

### SUMMARY

Some embodiments herein facilitate silent multi-factor authentication of a user of an application, based on subscription credentials that the user's communication device uses to access a communication network. Some embodiments in this regard engineer a domain name system (DNS) server in a communication network to advantageously insulate application providers from communication network details needed for a communication device to obtain a second factor from the communication network. Rather than requiring an application server to have different network-specific configurations in order for communication devices to obtain a second factor from different respective communication networks, some embodiments enable an application server to simply have a network-agnostic configuration usable for obtaining a second factor from any communication network. One or more embodiments for example perform DNS engineering so that an application server need simply redirect a user's communication device to a network-agnostic domain name for obtaining a second factor for authentication. Such a domain name thereby proves generic for any second factor server of any communication network. Some embodiments correspondingly engineer a DNS in a communication network to resolve the domain name into the address of the second factor server in the communication network that is configured to generate the second factor for authenticating the user of the application. These and other embodiments advantageously facilitate silent multi-factor authentication in a way that avoids burdening application providers and that works even for certain types of devices that have restricted APIs, e.g., the embodiments do not have any dependency with a communication device's operating system. According to other embodiments herein, a communication network generates a second factor using subscription credentials based on which a user's communication device accesses the communication network. The communication network notably generates the second factor to be specific to a connection or session established based on the subscription credentials. Generating the second factor in this way facilitates verification of the second factor by the application server and/or an aggregator.

More particularly, embodiments herein include a domain name system, DNS, server in a communication network for facilitating silent multi-factor authentication of a user of an application. The method comprises receiving, from a communication device on which the application executes, a DNS query requesting the DNS server to resolve a domain name that is generic for some second factor server of some communication network. The method also comprises resolving the domain name into an address of a second factor server in the communication network that is configured to generate a second factor for authenticating the user of the application. The method also comprises transmitting, to the communication device, a DNS response that indicates the address of the second factor server in the communication network.

In some embodiments, the second factor is a token, and the second factor server in the communication network is a token server.

In some embodiments, the second factor is a one-time passcode, and the second factor server in the communication network is a passcode server.

In some embodiments, the second factor server is configured to use subscription credentials based on which the communication device accesses the communication network to generate the second factor for authenticating the user of the application.

Other embodiments herein include a method performed by a second factor server in a communication network for facilitating silent multi-factor authentication of a user of an application. The method comprises receiving, from a communication device on which the application executes, a request for a second factor for authenticating the user of the application. The method also comprises, responsive to the request, generating the second factor using subscription credentials based on which the communication device accesses the communication network. In some embodiments, the second factor is generated to be specific to a connection or session established based on the subscription credentials. The method also comprises transmitting the second factor to the communication device in response to the request.

In some embodiments, the second factor is generated to include one or more pointers. In some embodiments, the one or more pointers include a network pointer comprising a pointer to the communication network. In other embodiments, the one or more pointers alternatively or additionally include an aggregator pointer comprising a pointer to an aggregator via which the second factor is verifiable.

In some embodiments, the second factor is a token, and the second factor server in the communication network is a token server.

In some embodiments, the second factor is a one-time passcode, and the second factor server in the communication network is a passcode server.

In some embodiments, the subscription credentials include a Mobile Station International Subscriber Directory Number, MSISDN. In other embodiments, the subscription credentials include an International Mobile Subscriber Identity, IMSI. In yet other embodiments, the subscription credentials include a Subscription Permanent Identifier, SUPI. In still yet other embodiments, the subscription credentials include Generic Public Subscription Identifier, GPSI. In some embodiments, the method further comprises obtaining the subscription credentials based on an Internet Protocol, IP, address of the communication device.

In some embodiments, the second factor is generated also to identify, or be specific to, the communication network as generator and/or verifier of the second factor.

In some embodiments, the method further comprises receiving, from aggregator equipment, a request to verify a presented second factor. The request includes the presented second factor and subscription information associated with a subscription to the communication network. The method in this case may also comprise determining whether or not the presented second factor is verified by determining whether or not the presented second factor matches a second factor previously generated by the communication network 10 for the subscription information included in the request. The method may then comprise transmitting, to the aggregator equipment, a response indicating whether or not the second factor is verified according to said determining.

Other embodiments herein include a method performed by aggregator equipment for facilitating silent multi-factor authentication of a user of an application. The method comprises receiving, from an application server for the application, a request to verify a second factor for authenticating the user of the application. In some embodiments, the request includes the second factor and subscription information associated with a subscription of the user to a communication network. The method also comprises identifying, from the second factor or from the subscription information, a communication network that is generator and/or verifier of the second factor. The method also comprises performing a verification procedure with the identified communication network, using the second factor and the subscription information included in the request, in an attempt to verify the second factor as authenticating the user of the application. The method also comprises transmitting a response to the request indicating whether or not the second factor is verified.

In some embodiments, performing the verification procedure comprises transmitting a verification request to the identified communication network that includes the second factor and the subscription information and that requests the identified communication network to verify the second factor, and receiving in response a verification result indicating whether or not the second factor is verified. In other embodiments, performing the verification procedure comprises transmitting a verification information request to the identified communication network that includes the subscription information and that requests the identified communication network to return a comparison second factor against which the second factor is verifiable, receiving the comparison second factor in response, and determining whether or not the second factor is verified by comparing the second factor with the comparison second factor.

In some embodiments, performing the verification procedure with the identified communication network comprises performing the verification procedure with a second factor server in the identified communication network.

In some embodiments, said identifying comprises retrieving a network pointer from the second factor. In some embodiments, the network point comprises a pointer to the communication network.

In some embodiments, the second factor is a token or a one-time passcode.

Other embodiments herein include a method for silent multi-factor authentication of a user of an application. The method comprises transmitting, by a communication device on which the application executes, a first factor for authenticating the user of the application to an application server for the application. The method also comprises receiving, at the communication device, from the application server, a domain name to which the communication device is redirected for obtaining a second factor for authenticating the user of the application to the application server. In some embodiments, the domain name is generic for some second factor server of some communication network. The method also comprises transmitting, by the communication device, to a domain name system, DNS, server of a communication network to which the communication device has subscription credentials, a DNS query requesting the DNS to resolve the domain name. The method also comprises receiving, by the communication device, a response to the DNS query indicating an address of a second factor server in the communication network. The method also comprises transmitting, by the communication device, to the address of the second factor server in the communication network, a request for a second factor for authenticating the user of the application. The method also comprises, responsive to the request, generating, by the second factor server, the second factor using subscription credentials based on which the communication device accesses the communication network. In some embodiments, the second factor is generated to be specific to a connection or session established based on the subscription credentials. The method also comprises transmitting the second factor from the second factor server to the communication device in response to the request. The method also comprises transmitting the second factor from the communication device to the application server for authenticating the user of the application to the application server. The method also comprises receiving, at aggregator equipment, from the application server, a request to verify the second factor. In some embodiments, the request includes the second factor and subscription information associated with a subscription of the user to the communication network. The method also comprises identifying, by the aggregator equipment, from the second factor or from the subscription information, the communication network as generator and/or verifier of the second factor. The method also comprises performing, by the aggregator equipment, a verification procedure with the communication network, using the second factor and the subscription information included in the request, in an attempt to verify the second factor as authenticating the user of the application. The method also comprises transmitting a response to the request from the 20 application server indicating whether or not the second factor is verified.

Other embodiments herein include a domain name system, DNS, server in a communication network for facilitating silent multi-factor authentication of a user of an application. The DNS comprises communication circuitry and processing circuitry. The processing circuitry is configured to receive, from a communication device on which the application executes, a DNS query requesting the DNS to resolve a domain name that is generic for some second factor server of some communication network. The processing circuitry is also configured to resolve the domain name into an address of a second factor server in the communication network that is configured to generate a second factor for authenticating the user of the application. The processing circuitry is also configured to transmit, to the communication device, a DNS response that indicates the address of the second factor server in the communication network.

In some embodiments, the processing circuitry is configured to perform the steps described above for a DNS in a communication network for facilitating silent multi-factor authentication of a user of an application.

Other embodiments herein include a second factor server in a communication network for facilitating silent multi-factor authentication of a user of an application. The second factor server comprises communication circuitry and processing circuitry. The processing circuitry is configured to receive, from a communication device on which the application executes, a request for a second factor for authenticating the user of the application. The processing circuitry is also configured to, responsive to the request, generate the second factor using subscription credentials based on which the communication device accesses the communication network. In some embodiments, the second factor is generated to be specific to a connection or session established based on the subscription credentials. The processing circuitry is also configured to transmit the second factor to the communication device in response to the request.

In some embodiments, the processing circuitry is configured to perform the steps described above for a second factor server in a communication network for facilitating silent multi-factor authentication of a user of an application.

Other embodiments herein include aggregator equipment for facilitating silent multi-factor authentication of a user of an application. The aggregator equipment comprises communication circuitry and processing circuitry. The processing circuitry is configured to receive, from an application server for the application, a request to verify a second factor for authenticating the user of the application. In some embodiments, the request includes the second factor and subscription information associated with a subscription of the user to a communication network. The processing circuitry is also configured to identify, from the second factor or from the subscription information, a communication network that is generator and/or verifier of the second factor. The processing circuitry is also configured to perform a verification procedure with the identified communication network, using the second factor and the subscription information included in the request, in an attempt to verify the second factor as authenticating the user of the application. The processing circuitry is also configured to transmit a response to the request indicating whether or not the second factor is verified. In some embodiments, the processing circuitry is configured to perform the steps described above for aggregator equipment for facilitating silent multi-factor authentication of a user of an application.

Other embodiments herein include a system for silent multi-factor authentication of a user of an application. The system comprises a communication device configured to execute the application. The system also comprises a domain name system, DNS, server of a communication network to which the communication device has subscription credentials. The system also comprises a second factor server in the communication network. The system also comprises aggregator equipment. In some embodiments, the communication device is configured to transmit a first factor for authenticating the user of the application to an application server for the application. The communication device is also configured to receive, from the application server, a domain name to which the communication device is redirected for obtaining a second factor for authenticating the user of the application to the application server. In some embodiments, the domain name is generic for some second factor server of some communication network. The communication device is also configured to transmit, to the DNS, a DNS query requesting the DNS to resolve the domain name. The communication device is also configured to receive a response to the DNS query indicating an address of the second factor server in the communication network. The communication device is also configured to transmit, to the address of the second factor server in the communication network, a request for a second factor for authenticating the user of the application. In some embodiments, the second factor server is configured to, responsive to the request, generate the second factor using the subscription credentials based on which the communication device accesses the communication network. In some embodiments, the second factor is generated to be specific to a connection or session established based on the subscription credentials. The second factor server is configured to transmit the second factor from the second factor server to the communication device in response to the request. In some embodiments, the communication device is configured to transmit the second factor from the communication device to the application server for authenticating the user of the application to the application server. In some embodiments, the aggregator equipment is configured to receive, from the application server, a request to verify the second factor. In some embodiments, the request includes the second factor and subscription information associated with a subscription of the user to a communication network. The aggregator equipment is also configured to identify, from the second factor or from the subscription information, the communication network as generator and/or verifier of the second factor. The aggregator equipment is also configured to perform a verification procedure with the communication network, using the second factor and the subscription information included in the request, in an attempt to verify the second factor as authenticating the user of the application. The aggregator equipment is also configured to transmit a response to the request from the application server indicating whether or not the second factor is verified.

In some embodiments, a computer program comprising instructions which, when executed by at least one processor of a domain name system, DNS, server in a communication network, causes the DNS to perform the steps described above for a DNS in a communication network for facilitating silent multi-factor authentication of a user of an application. In some embodiments, a computer program comprising instructions which, when executed by at least one processor of a second factor server in a communication network, causes the second factor server to perform the steps described above for a second factor server in a communication network for facilitating silent multi-factor authentication of a user of an application. In some embodiments, a computer program comprising instructions which, when executed by at least one processor of aggregator equipment, causes the aggregator equipment to perform the steps described above for aggregator equipment for facilitating silent multi-factor authentication of a user of an application. In some embodiments, a carrier containing the computer program is one of an electronic signal, optical signal, radio signal, or computer readable storage medium.

Of course, the present disclosure is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a communication network, a communication device, and an application server according to some embodiments.

FIG. 2 is a block diagram of a communication network, a communication device, aggregator equipment, and an application server according to some embodiments.

FIG. 3A is a block diagram of an example communication network that is a 5G network with a User Plane Function (UPF) according to some embodiments.

FIG. 3B is a call flow diagram of an example implementation of some embodiments for silent multi-factor authentication of a user of an application.

FIG. 4 is a logic flow diagram of a method performed by a DNS server according to some embodiments.

FIG. 5 is a logic flow diagram of a method performed by a second factor server according to some embodiments.

FIG. 6 is a logic flow diagram of a method performed by aggregator equipment according to some embodiments.

FIG. 7 is a block diagram of a DNS server according to some embodiments.

FIG. 8 is a block diagram of a second factor server according to some embodiments.

FIG. 9 is a block diagram of aggregator equipment according to some embodiments.

FIG. 10 shows an example of a communication system in accordance with some embodiments.

FIG. 11 is a block diagram of a host which may be an embodiment of the host of FIG. 10, in accordance with various aspects described herein.

### DETAILED DESCRIPTION

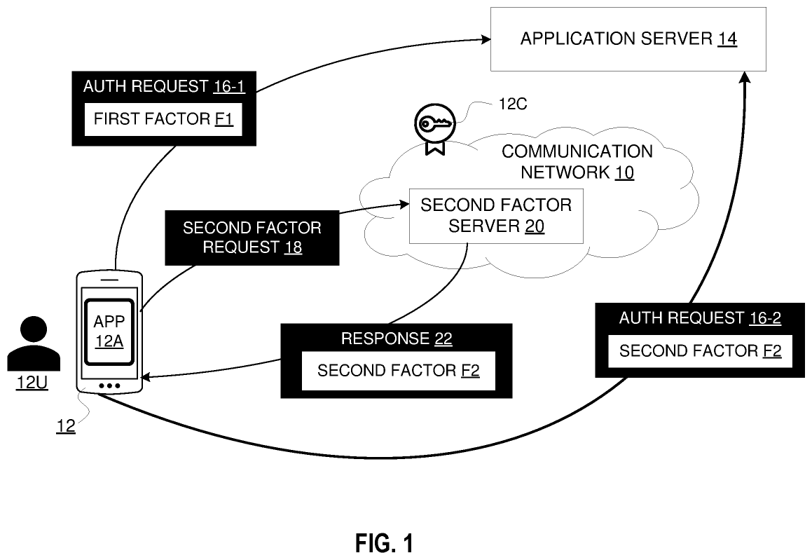

FIG. 1 shows a communication device 12 on which an application (app) 12A executes. The application 12A in some embodiments executes on top of an operating system (not shown) of the communication device 12. For example, the application 12A may rely on the operating system for access to the file system and/or other utilities.

The application 12A requires multi-factor authentication of the application's user 12U, e.g., two-factor authentication, as a prerequisite for the user 12U to use the application 12A. The user 12U as shown in this regard must authenticate himself or herself, using multiple factors of authentication, to an application server 14 that supports the application 12A. FIG. 1 accordingly shows that the application 12A transmits a first authentication request 16-1 to the application server 14, presenting a first factor F1 for authentication of the user 12U. The first factor F1 may for example concern something that the user 12U knows, e.g., a username and password/PIN. In one embodiment, successful authentication of the user 12U on the basis of this first factor F1 triggers acquisition of a second factor F2 for authenticating the user 12U. FIG. 1 accordingly shows that the application 12A also transmits a second authentication request 16-2 to the application server 14, presenting the second factor F2 for authentication of the user 12U.

According to embodiments herein, the second factor F2 concerns something that the user 12U has; namely, a subscription to a communication network 10, e.g., a 5G network. The second factor F2 may for example take the form of a token or one-time passcode that is generated on the basis of the user's subscription to the communication network 10. Exploiting the user's subscription to the communication network 10 as the basis for the second factor F2 advantageously enables authentication of the second factor F2 to be transparent or ‘silent’ to the user 12U, since authentication of the second factor F2 can be accomplished without interaction with the user 12U. In some embodiments, for example, successful authentication of the first factor F1 triggers the application 12A to autonomously transmit a request 18 for the second factor F2 to a second factor server 20 in the communication network 10 to which the user 12U holds a subscription. The second factor server 20 may for example be a token server or a passcode server, depending on whether the second factor F2 takes the form of a token or one-time passcode. Of course, in some embodiments, the user may at least be informed that the authentication of the second factor F2 is ongoing in the background, despite not seeking user input or interaction. Regardless, responsive to this request, the second factor server 20 generates the second factor F2 using subscription credentials 12C for the user's subscription to the communication network 10; that is, subscription credentials 12C based on which the communication device 12 accesses the communication network 10. The subscription credentials 12C may for example include a Mobile Station International Subscriber Directory Number (MSISDN), an International Mobile Subscriber Identity (IMSI), a Subscription Permanent Identifier (SUPI), a Generic Public Subscription Identifier (GPSI), or any other credentials specific to an individual subscription to the communication network 10. In these and other embodiments, the second factor server 20 may obtain the subscription credentials 12C based on the communication device's Internet Protocol (IP) address, e.g., by identifying which subscription the second factor request 18 relates from the IP address from which the second factor request 18 originates. Regardless, the second factor server 20 then returns the second factor F2 to the application 12A in a response 22, whereupon the application 12A includes the second factor F2 in the second authentication request 16-2 to the application server 14.

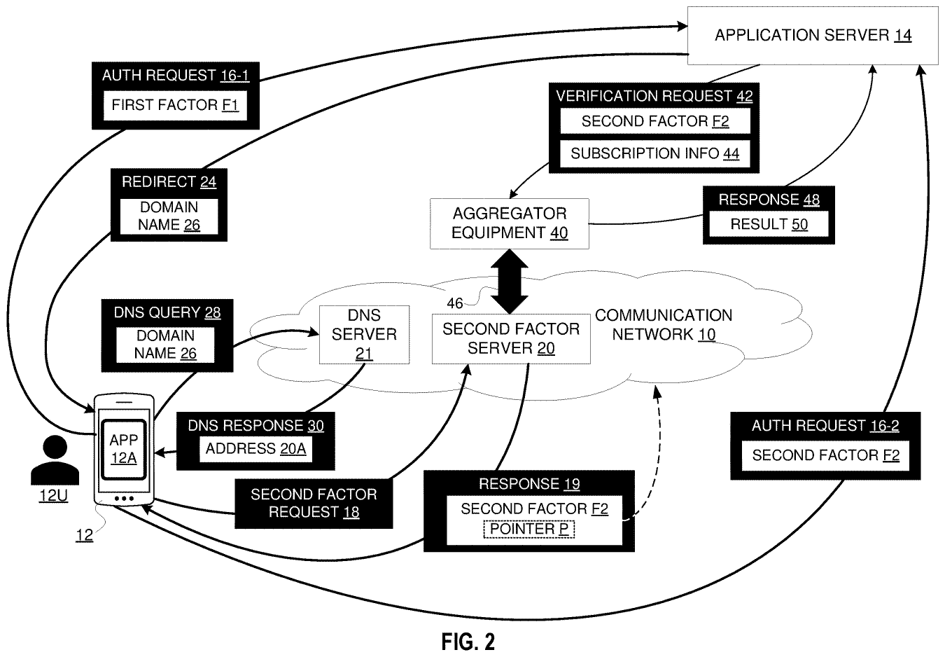

FIG. 2 shows additional details of silent multi-factor authentication according to some embodiments. As shown, after successful authentication of the first factor F1 in the first authentication request 16-1, the application server 14 transmits a redirect 24 to the application 12A, in order to redirect the application 12A to a different network domain for retrieval of the second factor F2 for authentication. The application server 14 in this regard includes a domain name 26 in the redirect 24, to redirect the application 12A to whatever network domain is identified by the domain name 26.

Notably, the domain name 26 is generic for some second factor server of some communication network, rather than being specific for one individual second factor server of one individual communication network. The domain name 26 is thereby generic in the sense that it is not specific to any individual second factor server and is not specific to any individual communication network. The domain name 26 accordingly just generically indicates a name associated with some second factor server of some communication network, without suggesting to which second factor server of which communication network the name is associated.

For example, the domain name 26 may be “2faServer.3gpp.com”. The domain name 26 in this case is generic for some second factor server of some 3^{rd} Generation Partnership Project (3GPP) network. That is, the domain name 26 just generically indicates a name associated with some second factor server of some 3GPP network, without suggesting to which second factor server of which 3GPP network the name is associated.

Note that the generic nature of the domain name 26 as used herein does not concern whether any words or phrases in the domain name 26 are themselves generic so as to be commonly found in the dictionary. Rather, the generic nature of the domain name 26 concerns the domain name's non-specificity as to which second factor server of which communication network the domain name 26 relates.

The generic nature of the domain name 26 means that the application server 14 need not discern or concern itself with which communication network 10 the application 12A is to acquire the second factor F2 from. The generic nature of the domain name 26 thereby advantageously insulates the application server 14 from details about from which specific communication network the application 12A is to retrieve the second factor F2. Accordingly, rather than requiring the application server 14 to redirect applications to different network-specific domain names depending on from which communication network the applications are to retrieve a second factor, embodiments herein enable the application server 14 to simply redirect any application to the same domain name 26 irrespective of the specific communication network from which the application is to retrieve a second factor. The domain name 26 in this sense is universal or common to multiple communication networks. Embodiments herein therefore advantageously facilitate silent multi-factor authentication in a way that avoids burdening the application server 14 with the details of how to direct different communication devices to different communication networks for retrieving a second factor.

Some embodiments enable use of such domain name 26 through domain name system (DNS) engineering that effectively resolves from which specific second factor server the application 12A is to retrieve the second factor F2. FIG. 2 in this regard shows that, after receiving the redirect 24 from the application server 14, the application 12A sends a DNS query 28 to a DNS server 21 in the communication network 10. The DNS query 28 includes the domain name 26 received from the application server 14 in the redirect 24. The DNS query 28 accordingly requests the DNS server 21 to resolve the domain name 26 that is generic for some second factor server of some communication network. As engineered to do so, the DNS server 21 resolves the domain name 26 into an address 20A of a second factor server 20 in the communication network 10 that is configured to generate the second factor F2 for authenticating the user 12U of the application 12A. The DNS server 21 may for example consult a table at the DNS server 21 that maps the domain name 26 to the address 20A of the second factor server 20 in the communication network 10. Having resolved the domain name 26, the DNS server 21 transmits, to the communication device 12, a DNS response 30 that indicates the address 20A of the second factor server 20 in the communication network 10. The address 20A may for example be the Internet Protocol (IP) address of the second factor server 20.

After receiving the address 20 of the second factor server 20 in the communication network 10, the application 12A transmits its request 18 for the second factor F2 to the second factor server 20, i.e., by addressing the request 18 to the address 20A returned in the DNS response 30 and transmitting the request 18 as addressed. The second factor server 20 generates the second factor F2 and returns the second factor F2 to the application 12A in a response 19. The application 12A can then proceed as explained in FIG. 1, by transmitting the second authentication request 16-2 to the application server 14 with the second factor F2.

Embodiments above that exploit DNS engineering in the communication network 10 rely on the application 12A to direct its DNS query 28 to the DNS server 21 in that communication network 10, as opposed to some other DNS server that is not engineered to resolve the domain name 26. According to some embodiments, then, the application 12A is configured in a way that steers or forces the application 12A to perform its DNS lookup with some communication network that has a DNS server engineered according to embodiments herein. The application 12A may for instance be configured with a requirement to perform its DNS lookup with a certain type of communication network, on the basis that communication networks of that type are expected to have a DNS server engineered according to embodiments herein. For example, the application 12A may be configured with a requirement to perform its DNS lookup with a 3rd Generation Partnership Project (3GPP) network, as distinguished for instance from a Wi-Fi network, on the basis that 3GPP networks each have a DNS server engineered according to embodiments herein. With such a requirement, the application 12A may direct its DNS query 28 to whichever 3GPP network the communication device 12 is capable of accessing, i.e., to whichever 3GPP network the communication device 12 has subscription credentials stored. In the context of FIG. 2's example, because the communication device 12 has subscription credentials for access to the communication network 10 (e.g., a 3GPP network), the application 12A directs its DNS query 28 to the communication network 10. And because the DNS server 21 in the communication network 10 is engineered to resolve the domain name 26 according to embodiments herein, the DNS server 21 is able to properly provide the application 12A with the address 20A of a second factor server 20 that can generate a second factor F2 for authenticating the user 12U.

Of course, insulating the application server 14 from having to know communication network details for the redirect 24 introduces challenges for how the application server 14 can verify the second factor F2 as in fact authenticating the user 12U of the application 14A. Indeed, in embodiments where the second factor F2 is generated using subscription credentials 12C based on which the communication device 12 accesses the communication network 10, the communication network may need to be involved in some way to verify the second factor F2. Some embodiments accordingly exploit an aggregator as an intermediary for verification of the second factor F2, to preserve transparency of the communication network to the application server 14. FIG. 2 in this regard shows that the application server 14 is configured to communicate with aggregator equipment 40 of an aggregator. Such an aggregator may be a cloud communications provider (e.g., Vonage®) or otherwise provide a service aggregated with service(s) of communication networks. In fact, the aggregator equipment 40 in some embodiments may provide its service to multiple communication networks, so that it is able to serve as an intermediary for verifying second factors from multiple communication networks. In these and other embodiments, then, the aggregator equipment 40 may function as a single point of contact for the application server 14 to verify any second factor generated by some communication network. In one embodiment, the application server 14 may be preconfigured with knowledge of (and the address of) the aggregator equipment 40 that is to serve as the intermediary for second factor verification. In another embodiment, though, the second factor F2 may be generated to include an aggregator pointer (not shown) that points to an aggregator that can verify the second factor F2.

In any event, upon receipt of the second authentication request 16-2 from the application 12A, the application server 14 in FIG. 2 effectively delegates verification of the second factor F2 to the aggregator equipment 40. The application server 14 in this regard need simply request the aggregator equipment 40 to verify the second factor F2, by transmitting a verification request 42 to the aggregator equipment 40 including the second factor F2. The application server 14 in turn receives a response 48 with the result 50 of the verification indicating whether or not the aggregator equipment 40 verified the second factor F2 as authenticating the user 12U. Delegating verification of the second factor F2 to the aggregator equipment 40 in this way advantageously preserves the simplicity of silent multi-factor authentication for the application server 14, as the application server 14 need not treat verification differently for different communication networks.

With second factor verification delegated to the aggregator equipment 40, some embodiments herein equip the aggregator equipment 40 with subscription information 44 that the user 12U presents as being associated with the user's subscription to the communication network 10. The subscription information 44 may for example include a Mobile Station Integrated Services Digital Network (MSISDN) or phone number that the user 12U presents as being associated with the user's subscription to the communication network 10. As shown in FIG. 2 in this regard, the application server 14 may include the subscription information 44 in its verification request 42 to the aggregator equipment 40, for the aggregator equipment 40 to use in verifying the second factor F2. The application server 14 may for instance have already acquired the subscription information 44 upon initial registration of the user with the application server 14.

In some embodiments, the aggregator equipment 40 identifies, from the subscription information 44 presented in the verification request 42, the communication network 10 with which to verify the second factor F2 presented in the verification request 42. The aggregator equipment 40 may for instance be configured with a mapping (e.g., database) which maps different possible subscription information to different possible communication networks, e.g., different possible MSISDNs to different communication networks or different MCC/MNC combinations to different communication networks.

In other embodiments, by contrast, the second factor F2 is generated to identify the communication network 10 as generator and/or verifier of the second factor F2. i.e., such that the communication network 10 is identifiable from the second factor F2 as generator and/or verifier of the second factor F2. As shown in FIG. 2, for example, the second factor server 20 may generate the second factor F2 to include a pointer P. This pointer P may be a network pointer that points to the communication network 10. Such a network pointer may for example take the form of a Mobile Network Code (MNC), e.g., in combination with a Mobile Country Code (MCC). Alternatively, the pointer P may take the form of a domain name specific to the communication network 10 or specific to the second factor server 20 in the communication network 10. In these and other embodiments, the aggregator equipment 40 can identify which communication network the aggregator equipment 40 needs to consult with in order to verify the second factor F2 received from the application server 14. The aggregator equipment 40 may for example retrieve the pointer P from the second factor F2.

Whether from the subscription information 44 or the second factor F2, then, the aggregator equipment 40 may identify the communication network 10 with which to verify the second factor F2 presented in the verification request 42. The aggregator equipment 40 as shown in FIG. 2 performs a verification procedure 46 with this identified communication network 10, e.g., with the second factor server 20 in the identified communication network 10. The aggregator equipment 40 performs this verification procedure 46 in an attempt to verify the second factor F2 as authenticating the user 12U of the application 14A. The aggregator equipment 40 may use the second factor F2 and the subscription information 44 included in the verification request 42 for this verification procedure 46.

The verification procedure 46 may for example involve the aggregator equipment 40 transmitting its own verification request (not shown) to the communication network 10. This verification request may include the second factor F2 and the subscription information 44, and may request the communication network 10 to verify the second factor F2 as authenticating the user 12U of the application 14A. The aggregator equipment 40 may receive in response a verification result (not shown) indicating whether or not the second factor F2 is verified.

As an alternative, the verification procedure 46 may instead involve the aggregator equipment 40 transmitting a verification information request (not shown) to the communication network 10. This verification information request may just include the subscription information 44. The verification information request may request the communication network 10 to return a comparison second factor against which the second factor F2 is verifiable. Upon receiving the requested comparison second factor, the aggregator equipment 40 may determine whether or not the second factor F2 is verified by comparing the second factor F2 with the comparison second factor. If for example the comparison second factor matches the second factor F2 presented in the verification request 42, the aggregator equipment 40 deems the presented second factor F2 as verified.

According to some embodiments in this regard, the second factor server 20 generates the second factor F2 to be specific to a connection or session established based on the subscription credentials (12C), e.g., a Packet Data Network (PDN) connection or a Protocol Data Unit (PDU) Session. The second factor F2 in one such embodiment is generated to be unique, at least within the communication network 10, e.g., so that the second factor F2 is unique to the specific connection or session that the communication device 12 has with the communication network 10, at least from the perspective of the communication network 10. In some embodiments, as an example, the second factor server 20 generates the second factor F2 as a function of an identity of the connection or session established by the communication device 12, e.g., where the second factor F2 may take the form of a string with a value that is pseudo randomly generated as a function of the identity of the connection or session.

In these and other embodiments, then, a second factor presented in the verification request 42 for verification is verified if the presented second factor matches a second factor that has been previously generated for the subscription information 44 presented in the verification request 42. For example, in embodiments where the aggregator equipment 40 forwards the presented second factor and subscription information 44 to the second factor server 20 for verification, the second factor server 20 may determine whether or not the presented second factor is verified. The second factor server 20 may for example determine whether or not the presented second factor matches a second factor previously generated for the subscription information included in the verification request. If such a match exists, the second factor server 20 may deem the presented second factor as verified. If no such match exists, the second factor server 20 may instead deem the presented second factor as not verified.

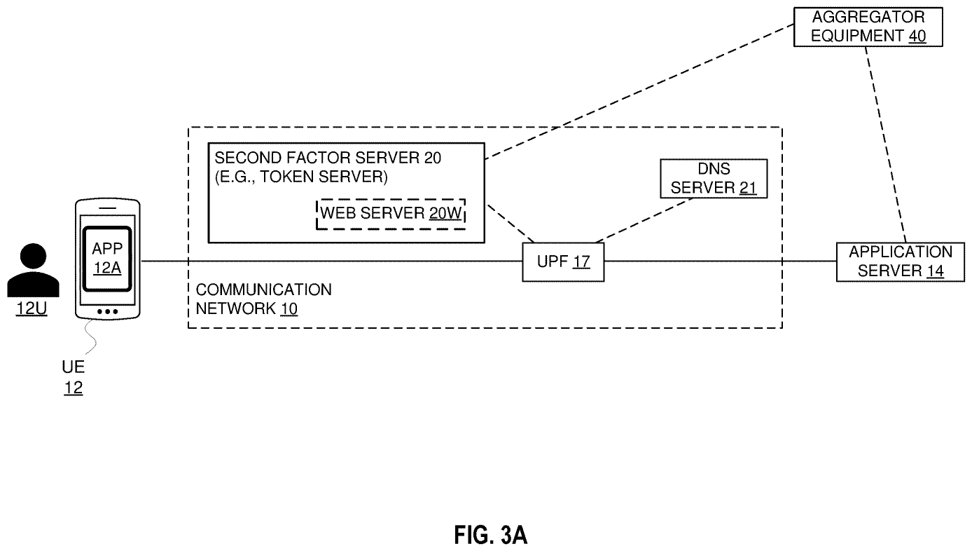

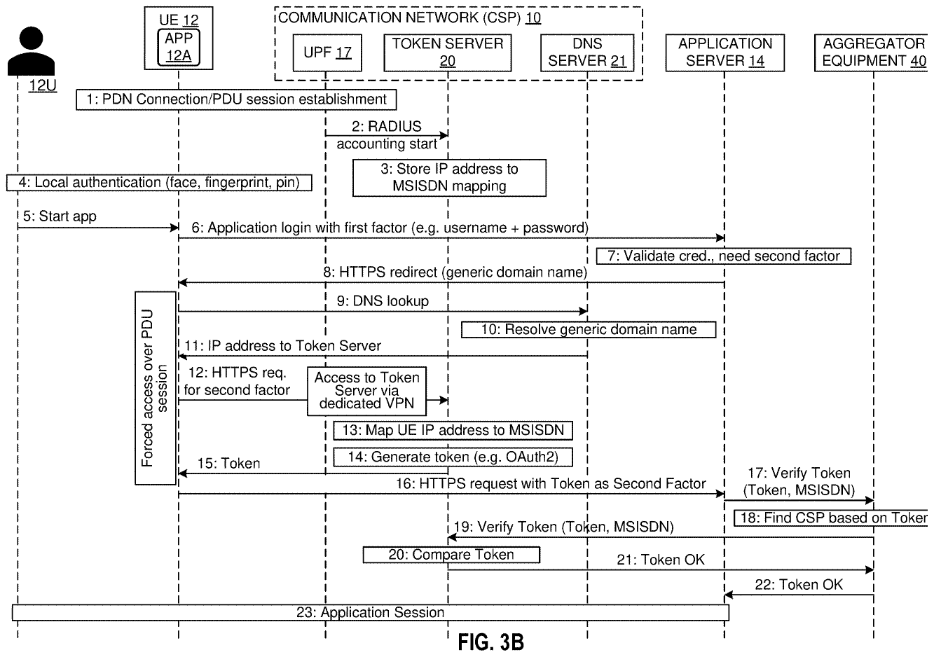

FIGS. 3A-3B illustrate one example of some embodiments. In this example, as shown in FIG. 3A, the communication device 12 is exemplified as a user equipment (UE), and the communication network 10 is exemplified as a 5G network that includes a User Plane Function (UPF) 17 via which the UE 12 accesses the application server 14, the second factor server 20, and the DNS server 21. The UPF 17 in particular supports features and capabilities to facilitate user plane operation, e.g., packet routing and forwarding as well as interconnection to a Data Network (e.g., the Internet). Furthermore, the second factor server 20 is exemplified as a token server 20. In one such embodiment, the token server 20 includes or is co-located with a web server 20W, for communication via web protocols such as HyperText Transfer Protocol (HTTP) or HTTP Secure (HTTPS).

FIG. 3B in particular shows that the UE 12 may first establish a Packet Data Network (PDN) connection or Protocol Data Unit (PDU) session with the UPF 17 in the communication network 10 (Step 1). This prompts the UPF 17 to trigger the token server 20 to start Remote Authentication Dial-In User Service (RADIUS) accounting (Step 2), whereupon the token server 20 stores a mapping which maps the IP address of the UE 12 to the MSISDN associated with the user's subscription to the communication network (Step 3).

Sometime thereafter, the user 12U may perform local authentication for access to the communication device 12, e.g., via face ID, fingerprint, PIN, etc. (Step 4). The user 12U then starts the application 12A, which may or may not be web browser based (Step 5). The user 12U then initiates the process of authenticating himself or herself to the application server 14. The user 12U as shown in this regard inputs logic credentials as the first factor F1, e.g., in the form of a username and password, whereupon the application 12A transmits an application login message with the login credentials to the application server 14 (Step 6). Here, the application login message exemplifies the first authentication request 16-1 in FIG. 1. Upon validation of the login credentials (Step 7), the application server 14 triggers the process for silent multi-factor authentication by informing the application 12A that a second factor F2 is required for authentication of the user 12U.

In particular, the application server 14 transmits, to the application 12A, an HTTP redirect message 24 that redirects the application 12A for the purpose of acquiring a second factor F2 for authentication (Step 8). This redirect message 24 includes a domain name 26 which is generic for some token server in some communication network (Step 8). In fact, in some embodiments, the domain name 26 included in the redirect message 24 is the same for all users of the application 12A, independent of or regardless of which communication network each user uses to access the application server 14. In any event, the application 12A next triggers a DNS lookup (Step 9) to resolve the received domain name 26. At this stage, though, the application 12A is configured to force access over its PDU session with the communication network 10, so as to force its DNS lookup to be made over the PDU session with the communication network 10. Accordingly, even if Steps 6-8 were performed over some other network (e.g., Wi-Fi), the application 12A now forces its DNS lookup in Step 9 to be made to the communication network 10. The DNS server 21 in the communication network 10 correspondingly fields the DNS lookup and resolves the domain name 26 into the IP address of the token server 20, which is capable of communicating via web protocols (Step 10). The DNS server 21 then returns the IP address of the SES in a response to the DNS lookup request (Step 11).

Now informed of the IP address of the token server 20, the application 12A transmits an HTTPS request for the second factor F2 to the token server 20 (Step 12), where this HTTPS request exemplifies the second factor request 18 in FIG. 2. The application 12A in particular addresses its HTTPS request with the IP address received in response to its DNS lookup. In some embodiments, though, the communication network 10 guards access to the token server 20 with a dedicated Virtual Private Network (VPN) between the UPF 17 and the token server 20. This means that only a node internal to the communication network 10 can reach the token server 20. Upon reception of the HTTPS request for the second factor F2, then, the UPF 17 forwards that HTTPS request to the token server 20 through the dedicated VPN. In some embodiments, for example, the UPF 17 filters on the destination IP address of the token server 20 and forwards the HTTPS request on the dedicated VPN. In some embodiments, the token server 20 verifies that the HTTPS request is received over this dedicated (trusted) VPN as a prerequisite for responding.

Upon receipt of the HTTPS request for a second factor F2 for authenticating the user 12U, the token server 20 maps the UE's IP address to the MSISDN associated with the user's subscription to the communication network 10 (Step 13), e.g., according to the mapping stored in Step 3. The token server 20 then generates the second factor F2 in the form of a Token, e.g., an OAuth2 token or an Open ID connect (Step 14). The token server 20 generates this Token using the MSISDN associated with the user's subscription, where this MSISDN exemplifies subscription credentials 12C based on which the UE 12 accesses the communication network 10. In some embodiments, the token server 20 generates the Token to be specific to the PDN connection or PDU session that the UE 12 established with the UPF 17, e.g., by pseudo randomly generating the Token as a function of an identity of the PDN connection or PDU session. The token server 20 then returns the Token as a response to the HTTP request (Step 15), where the response with the Token exemplifies the response 19 in FIG. 2.

Equipped with the Token as the second factor F2, the application 12A next transmits an HTTPS request to the application server 14, requesting authentication of the user 12U on the basis of the Token (Step 16). This HTTPS request includes the Token as the second factor F2 and exemplifies the second authentication request 16-2 in FIG. 2. Note here that forced access over the PDU session is no longer required as of Step 16, meaning that the HTTPS request may be transmitted over any access.

The application server 14 employs the aggregator equipment 40 for verifying the received Token, e.g., as an example of the verification procedure 46 in FIG. 2. The application server 14 in particular transmits, to the aggregator equipment 40, a request to verify the Token, where the request includes the Token and the MSISDN (Step 17). The request accordingly presents the Token for verification in connection with the presented MSISDN. This request exemplifies the verification request 42 in FIG. 2.

The aggregator equipment 40 finds the communication network 10 (communication service provider, CSP) based on the presented MSISDN (Step 18), e.g., by mapping the presented MSISDN to the communication network 10. In other embodiment, by contrast, the Token may include a pointer P to the communication network 10. Regardless, the aggregator equipment 40 then transmits, to the identified communication network 10, a request for the communication network 10 to verify the Token (Step 19). This request includes the Token and the MSISDN. The token server 20 fields this request. The token server 20 uses the MSISDN included in the request to generate a comparison Token, where the comparison Token is the token that is valid based on the provided MSISDN. The token server 20 correspondingly compares the generated comparison token to the Token presented in the request from the aggregator equipment 40 (Step 20). If the comparison token matches the presented Token, the token server 20 declares the presented Token as verified and returns a response that the Token is ‘Ok’ (Step 21). Otherwise (not shown), if the comparison token does not match the presented Token, the token server 20 may return an error response or otherwise indicate that the Token is not verified. Assuming that the Token is verified, though, the aggregator equipment 40 transmits a response to the application server 14 indicating that the Token is ‘Ok’ (Step 22). With the Token verified according to the aggregator equipment 40, the application server 14 deems that the user 12U authenticated according to the Token. Provided that the user 12U is otherwise authenticated and all requirements for proceeding with the application session are met, the application session may then proceed (Step 23).

Although the second factor server 20 is exemplified as a token server 20 in FIGS. 3A-3B, the second factor server 20 may be implemented by any network equipment or network function in the communication network 10.

Note also that the second factor F2 as used herein refers to any factor of user authentication that supplements another factor of user authentication, e.g., an initial factor, regardless of whether or not the second factor F2 is actually second in any ordering of factors for user authentication. In some embodiments, for example, authentication of the second factor F2 herein may be carried out together with or before authentication of the first factor F1 herein. In this case, though, the user 12U or application 12A may need to indicate the subscription information 44 (e.g., MSISDN) to the application server 14 as part of the second factor request 18 or otherwise.

Generally, some embodiments prove advantageous for silent multi-factor authentication in that the embodiments do not have any device application impact. Furthermore, in some embodiments, standard HTTP(S) messages are used, with limited impact on applications. Also advantageous is that the user need only provide the first factor F1 (e.g., username and password), and need not even provide the user's phone number or other information as the basis for the second factor F2. Moreover, some embodiments are advantageous in that applications don't have to “know about” communication service providers. Still further, some embodiments prove advantageous in that they work for both 3GPP access and Wi-Fi on a communication device, e.g., the access type used may be only restricted for second factor acquisition but can otherwise flexibly be any access type desired by the user 12U.

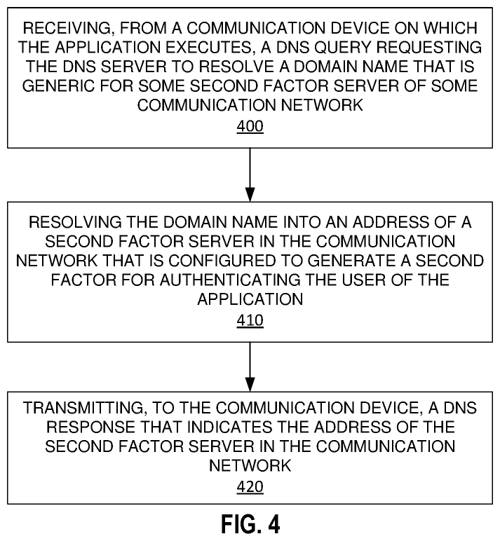

In view of the modifications and variations herein, FIG. 4 depicts a method performed by a domain name system, DNS, server 21 in a communication network 10 for facilitating silent multi-factor authentication of a user 12U of an application 12A in accordance with particular embodiments. The method includes receiving, from a communication device 12 on which the application 12A executes, a DNS query 28 requesting the DNS server 21 to resolve a domain name 26 that is generic for some second factor server of some communication network (Block 400). The method also includes resolving the domain name 26 into an address 20A of a second factor server 20 in the communication network 10 that is configured to generate a second factor F2 for authenticating the user 12U of the application 12A (Block 410). The method also includes transmitting, to the communication device 12, a DNS response 30 that indicates the address 20A of the second factor server 20 in the communication network 10 (Block 420).

In some embodiments, the second factor F2 is a token, and the second factor server 20 in the communication network 10 is a token server.

In some embodiments, the second factor F2 is a one-time passcode, and the second factor server 20 in the communication network 10 is a passcode server.

In some embodiments, the second factor server 20 is configured to use subscription credentials 12C based on which the communication device 12 accesses the communication network 10 to generate the second factor F2 for authenticating the user 12U of the application 12A.

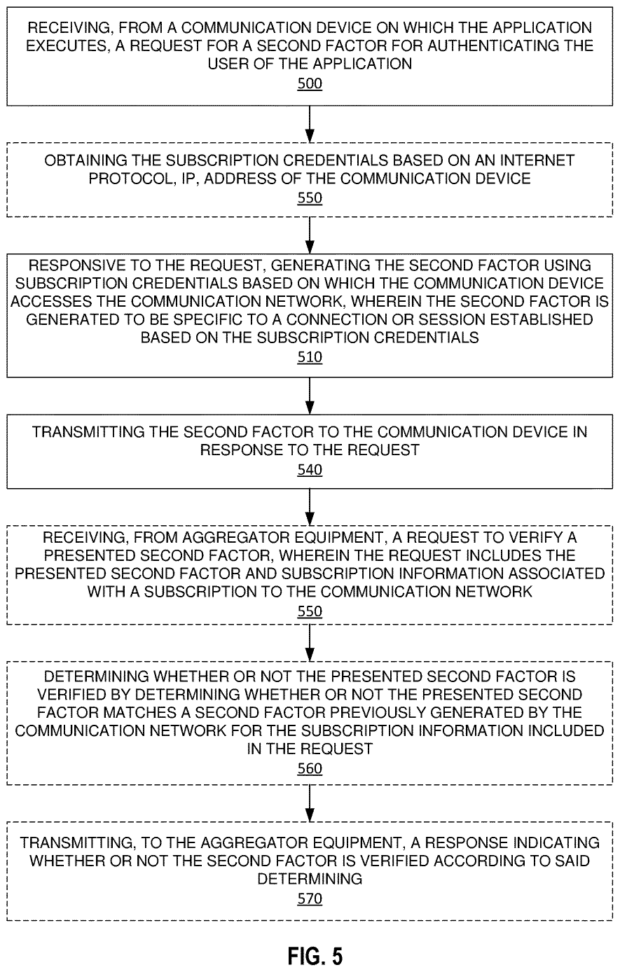

FIG. 5 depicts a method performed by a second factor server 20 in a communication network 10 for facilitating silent multi-factor authentication of a user 12U of an application 12A in accordance with other particular embodiments. The method includes receiving, from a communication device 12 on which the application 12A executes, a request 18 for a second factor F2 for authenticating the user 12U of the application 12A (Block 500). The method also includes, responsive to the request 18, generating the second factor F2 using subscription credentials 12C based on which the communication device 12 accesses the communication network 10 (Block 510). In some embodiments, the second factor F2 is generated to be specific to a connection or session established based on the subscription credentials 12C (Block 530). The method also includes transmitting the second factor F2 to the communication device 12 in response to the request 18 (Block 540).

In some embodiments, the method also includes obtaining the subscription credentials 12C based on an Internet Protocol, IP, address of the communication device 12 (Block 550).

In some embodiments, the second factor F2 is generated to include one or more pointers P. In some embodiments, the one or more pointers P include a network pointer comprising a pointer to the communication network 10. In other embodiments, the one or more pointers P alternatively or additionally include an aggregator pointer comprising a pointer to an aggregator via which the second factor F2 is verifiable.

In some embodiments, the second factor F2 is a token, and the second factor server 20 in the communication network 10 is a token server.

In some embodiments, the second factor F2 is a one-time passcode, and the second factor server 20 in the communication network 10 is a passcode server.

In some embodiments, the subscription credentials 12C include a Mobile Station International Subscriber Directory Number, MSISDN. In other embodiments, the subscription credentials 12C include an International Mobile Subscriber Identity, IMSI. In yet other embodiments, the subscription credentials 12C include a Subscription Permanent Identifier, SUPI. In still yet other embodiments, the subscription credentials 12C include a Generic Public Subscription Identifier, GPSI.

In some embodiments, the method further comprises receiving, from aggregator equipment 40, a request 42 to verify a presented second factor (Block 550). The request 42 includes the presented second factor and subscription information 44 associated with a subscription to the communication network 10. The method in this case may also comprise determining whether or not the presented second factor is verified by determining whether or not the presented second factor matches a second factor previously generated by the communication network 10 for the subscription information 44 included in the request 42 (Block 560). The method may then comprise transmitting, to the aggregator equipment 40, a response indicating whether or not the second factor F2 is verified according to said determining (Block 570).

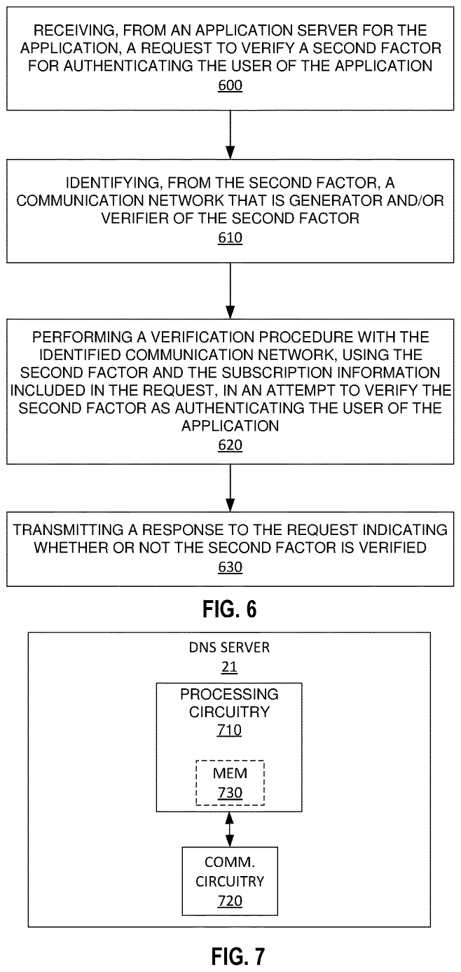

FIG. 6 depicts a method performed by aggregator equipment 40 for facilitating silent multi-factor authentication of a user 12U of an application 12A in accordance with other particular embodiments. The method includes receiving, from an application server 14 for the application 12A, a request 42 to verify a second factor F2 for authenticating the user 12U of the application 12A (Block 600). In some embodiments, the request 42 includes the second factor F2 and subscription information 44 associated with a subscription of the user 12U to a communication network 10. The method also includes identifying, from the second factor F2 or from the subscription information 44, a communication network 10 that is generator and/or verifier of the second factor (Block 610). The method also includes performing a verification procedure 46 with the identified communication network 10, using the second factor F2 and the subscription information 44 included in the request 42, in an attempt to verify the second factor F2 as authenticating the user 12U of the application 12A (Block 620). The method also includes transmitting a response 48 to the request 42 indicating whether or not the second factor F2 is verified (Block 630).

In some embodiments, performing the verification procedure 46 comprises transmitting a verification request to the identified communication network 10 that includes the second factor F2 and the subscription information 44 and that requests the identified communication network 10 to verify the second factor F2, and receiving in response a verification result indicating whether or not the second factor F2 is verified. In other embodiments, performing the verification procedure 46 comprises transmitting a verification information request to the identified communication network 10 that includes the subscription information 44 and that requests the identified communication network 10 to return a comparison second factor against which the second factor F2 is verifiable, receiving the comparison second factor in response, and determining whether or not the second factor F2 is verified by comparing the second factor with the comparison second factor.

In some embodiments, performing the verification procedure 46 with the identified communication network 10 comprises performing the verification procedure 46 with a second factor server 20 in the identified communication network 10.

In some embodiments, said identifying comprises retrieving a network pointer from the second factor F2. In some embodiments, the network point comprises a pointer to the communication network 10.

In some embodiments, the second factor F2 is a token or a one-time passcode.

The methods in FIGS. 4-6 may be implemented separately or in combination.

Embodiments herein also include corresponding apparatuses. Embodiments herein for instance include a DNS server 21 configured to perform any of the steps of any of the embodiments described above for the DNS server 21.

Embodiments also include a DNS server 21 comprising processing circuitry and power supply circuitry. The processing circuitry is configured to perform any of the steps of any of the embodiments described above for the DNS server 21. The power supply circuitry is configured to supply power to the DNS server 21.

Embodiments further include a DNS server 21 comprising processing circuitry. The processing circuitry is configured to perform any of the steps of any of the embodiments described above for the DNS server 21. In some embodiments, the DNS server 21 further comprises communication circuitry.

Embodiments further include a DNS server 21 comprising processing circuitry and memory. The memory contains instructions executable by the processing circuitry whereby the DNS server 21 is configured to perform any of the steps of any of the embodiments described above for the DNS server 21.

Embodiments herein also include a second factor server 20 configured to perform any of the steps of any of the embodiments described above for the second factor server 20.

Embodiments also include a second factor server 20 comprising processing circuitry and power supply circuitry. The processing circuitry is configured to perform any of the steps of any of the embodiments described above for the second factor server 20. The power supply circuitry is configured to supply power to the second factor server 20.

Embodiments further include a second factor server 20 comprising processing circuitry. The processing circuitry is configured to perform any of the steps of any of the embodiments described above for the second factor server 20. In some embodiments, the second factor server 20 further comprises communication circuitry.

Embodiments further include a second factor server 20 comprising processing circuitry and memory. The memory contains instructions executable by the processing circuitry whereby the second factor server 20 is configured to perform any of the steps of any of the embodiments described above for the second factor server 20.

Embodiments herein also include aggregator equipment 40 configured to perform any of the steps of any of the embodiments described above for the aggregator equipment 40.

Embodiments also include aggregator equipment 40 comprising processing circuitry and power supply circuitry. The processing circuitry is configured to perform any of the steps of any of the embodiments described above for the aggregator equipment 40. The power supply circuitry is configured to supply power to the aggregator equipment 40.

Embodiments further include aggregator equipment 40 comprising processing circuitry. The processing circuitry is configured to perform any of the steps of any of the embodiments described above for the aggregator equipment 40. In some embodiments, the aggregator equipment 40 further comprises communication circuitry.

Embodiments further include aggregator equipment 40 comprising processing circuitry and memory. The memory contains instructions executable by the processing circuitry whereby the aggregator equipment 40 is configured to perform any of the steps of any of the embodiments described above for the aggregator equipment 40.

Some embodiments also include a system for silent multi-factor authentication of a user 12U of an application 12A. The system comprises a communication device configured to execute the application 12A. The system also comprises a domain name system, DNS, server of a communication network 10 to which the communication device has subscription credentials. The system also comprises a second factor server in the communication network 10. The system also comprises aggregator equipment.

More particularly, the apparatuses described above may perform the methods herein and any other processing by implementing any functional means, modules, units, or circuitry. In one embodiment, for example, the apparatuses comprise respective circuits or circuitry configured to perform the steps shown in the method figures. The circuits or circuitry in this regard may comprise circuits dedicated to performing certain functional processing and/or one or more microprocessors in conjunction with memory. For instance, the circuitry may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory may include program instructions for executing one or more telecommunications and/or data communications protocols as well as instructions for carrying out one or more of the techniques described herein, in several embodiments. In embodiments that employ memory, the memory stores program code that, when executed by the one or more processors, carries out the techniques described herein.

FIG. 7 for example illustrates a DNS server 21 as implemented in accordance with one or more embodiments. As shown, the DNS server 21 includes processing circuitry 710 and communication circuitry 720. The communication circuitry 720 is configured to transmit and/or receive information to and/or from one or more other nodes, e.g., via any communication technology. The processing circuitry 710 is configured to perform processing described above, e.g., in FIG. 4, such as by executing instructions stored in memory 730. The processing circuitry 710 in this regard may implement certain functional means, units, or modules.

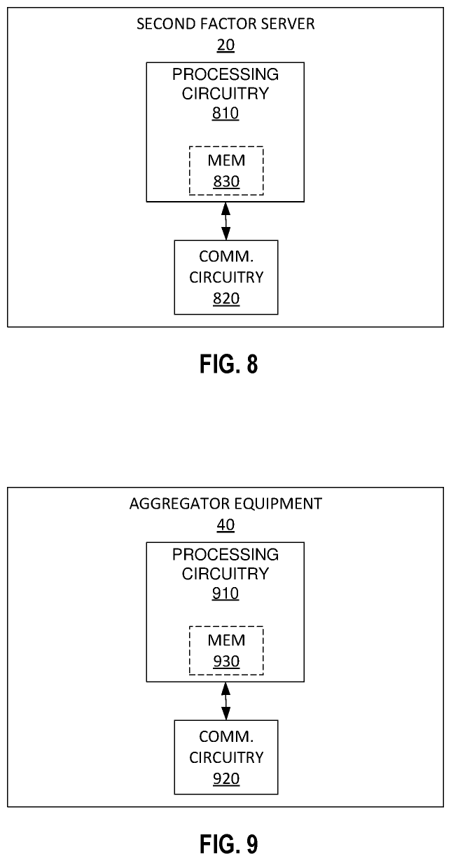

FIG. 8 illustrates a second factor server 20 as implemented in accordance with one or more embodiments. As shown, the second factor server 20 includes processing circuitry 810 and communication circuitry 820. The communication circuitry 820 is configured to transmit and/or receive information to and/or from one or more other nodes, e.g., via any communication technology. The processing circuitry 810 is configured to perform processing described above, e.g., in FIG. 5, such as by executing instructions stored in memory 830. The processing circuitry 810 in this regard may implement certain functional means, units, or modules.

FIG. 9 illustrates aggregator equipment 40 as implemented in accordance with one or more embodiments. As shown, the aggregator equipment 40 includes processing circuitry 910 and communication circuitry 820. The communication circuitry 920 is configured to transmit and/or receive information to and/or from one or more other nodes, e.g., via any communication technology. The processing circuitry 910 is configured to perform processing described above, e.g., in FIG. 6, such as by executing instructions stored in memory 930. The processing circuitry 910 in this regard may implement certain functional means, units, or modules.

Those skilled in the art will also appreciate that embodiments herein further include corresponding computer programs.

A computer program comprises instructions which, when executed on at least one processor of a DNS server 21, cause the DNS server 21 to carry out any of the respective processing described above. A computer program in this regard may comprise one or more code modules corresponding to the means or units described above.

In other embodiments, a computer program comprises instructions which, when executed on at least one processor of a second factor server 20, cause the second factor server 20 to carry out any of the respective processing described above. A computer program in this regard may comprise one or more code modules corresponding to the means or units described above.

In yet other embodiments, a computer program comprises instructions which, when executed on at least one processor of aggregator equipment 40, cause the aggregator equipment 40 to carry out any of the respective processing described above. A computer program in this regard may comprise one or more code modules corresponding to the means or units described above.

Embodiments further include a carrier containing any such computer program. This carrier may comprise one of an electronic signal, optical signal, radio signal, or computer readable storage medium.

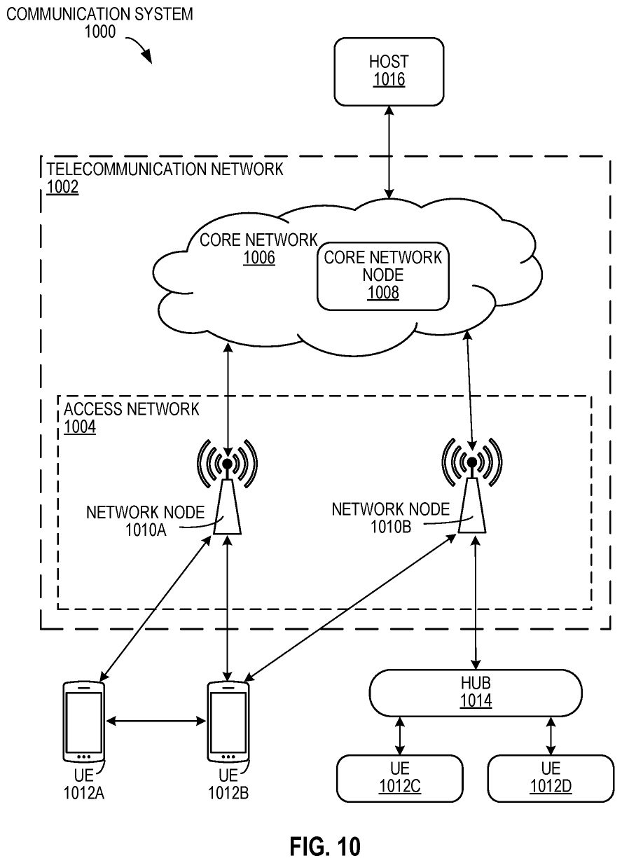

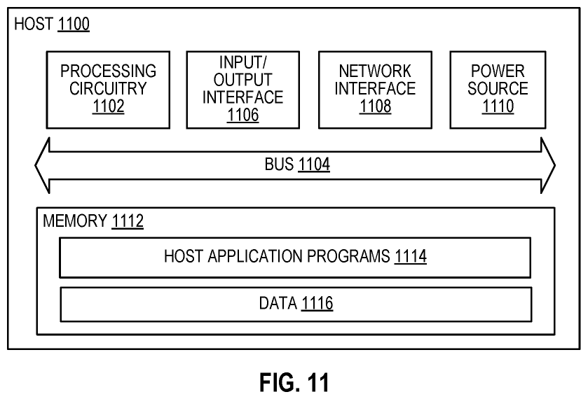

FIG. 10 shows an example of a communication system 1000 in accordance with some embodiments, as an example of communication network 10 in some embodiments.

In the example, the communication system 1000 includes a telecommunication network 1002 that includes an access network 1004, such as a radio access network (RAN), and a core network 1006, which includes one or more core network nodes 1008. The access network 1004 includes one or more access network nodes, such as network nodes 1010a and 1010b (one or more of which may be generally referred to as network nodes 1010), or any other similar 3rd Generation Partnership Project (3GPP) access node or non-3GPP access point. The network nodes 1010 facilitate direct or indirect connection of user equipment (UE), such as by connecting UEs 1012a, 1012b, 1012c, and 1012d (one or more of which may be generally referred to as UEs 1012) to the core network 1006 over one or more wireless connections. Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1000 may include any number of wired or wireless networks, network nodes, UEs, and/or any other components or systems that may facilitate or participate in the communication of data and/or signals whether via wired or wireless connections. The communication system 1000 may include and/or interface with any type of communication, telecommunication, data, cellular, radio network, and/or other similar type of system.

The UEs 1012 may be any of a wide variety of communication devices, including wireless devices arranged, configured, and/or operable to communicate wirelessly with the network nodes 1010 and other communication devices. Similarly, the network nodes 1010 are arranged, capable, configured, and/or operable to communicate directly or indirectly with the UEs 1012 and/or with other network nodes or equipment in the telecommunication network 1002 to enable and/or provide network access, such as wireless network access, and/or to perform other functions, such as administration in the telecommunication network 1002.

In the depicted example, the core network 1006 connects the network nodes 1010 to one or more hosts, such as host 1016. These connections may be direct or indirect via one or more intermediary networks or devices. In other examples, network nodes may be directly coupled to hosts. The core network 1006 includes one more core network nodes (e.g., core network node 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1016 may be under the ownership or control of a service provider other than an operator or provider of the access network 1004 and/or the telecommunication network 1002, and may be operated by the service provider or on behalf of the service provider. The host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1002 is a cellular network that implements 3GPP standardized features. Accordingly, the telecommunications network 1002 may support network slicing to provide different logical networks to different devices that are connected to the telecommunication network 1002. For example, the telecommunications network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 1014 communicates with the access network 1004 to facilitate indirect communication between one or more UEs (e.g., UE 1012c and/or 1012d) and network nodes (e.g., network node 1010b). In some examples, the hub 1014 may be a controller, router, content source and analytics, or any of the other communication devices described herein regarding UEs. For example, the hub 1014 may be a broadband router enabling access to the core network 1006 for the UEs. As another example, the hub 1014 may be a controller that sends commands or instructions to one or more actuators in the UEs. Commands or instructions may be received from the UEs, network nodes 1010, or by executable code, script, process, or other instructions in the hub 1014. As another example, the hub 1014 may be a data collector that acts as temporary storage for UE data and, in some embodiments, may perform analysis or other processing of the data. As another example, the hub 1014 may be a content source. For example, for a UE that is a VR headset, display, loudspeaker or other media delivery device, the hub 1014 may retrieve VR assets, video, audio, or other media or data related to sensory information via a network node, which the hub 1014 then provides to the UE either directly, after performing local processing, and/or after adding additional local content. In still another example, the hub 1014 acts as a proxy server or orchestrator for the UEs, in particular in if one or more of the UEs are low energy IoT devices.

The hub 1014 may have a constant/persistent or intermittent connection to the network node 1010b. The hub 1014 may also allow for a different communication scheme and/or schedule between the hub 1014 and UEs (e.g., UE 1012c and/or 1012d), and between the hub 1014 and the core network 1006. In other examples, the hub 1014 is connected to the core network 1006 and/or one or more UEs via a wired connection. Moreover, the hub 1014 may be configured to connect to an M2M service provider over the access network 1004 and/or to another UE over a direct connection. In some scenarios, UEs may establish a wireless connection with the network nodes 1010 while still connected via the hub 1014 via a wired or wireless connection. In some embodiments, the hub 1014 may be a dedicated hub—that is, a hub whose primary function is to route communications to/from the UEs from/to the network node 1010b. In other embodiments, the hub 1014 may be a non-dedicated hub—that is, a device which is capable of operating to route communications between the UEs and network node 1010b, but which is additionally capable of operating as a communication start and/or end point for certain data channels.

FIG. 11 is a block diagram of a host 1100, which may be an embodiment of the host 1016 of FIG. 10, in accordance with various aspects described herein. As used herein, the host 1100 may be or comprise various combinations hardware and/or software, including a standalone server, a blade server, a cloud-implemented server, a distributed server, a virtual machine, container, or processing resources in a server farm. The host 1100 may provide one or more services to one or more UEs.

The host 1100 includes processing circuitry 1102 that is operatively coupled via a bus 1104 to an input/output interface 1106, a network interface 1108, a power source 1110, and a memory 1112. Other components may be included in other embodiments. Features of these components may be substantially similar to those described with respect to the devices of previous figures, such as FIGS. 11 and QQ3, such that the descriptions thereof are generally applicable to the corresponding components of host 1100.

The memory 1112 may include one or more computer programs including one or more host application programs 1114 and data 1116, which may include user data, e.g., data generated by a UE for the host 1100 or data generated by the host 1100 for a UE. Embodiments of the host 1100 may utilize only a subset or all of the components shown. The host application programs 1114 may be implemented in a container-based architecture and may provide support for video codecs (e.g., Versatile Video Coding (WVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1114 may also provide for user authentication and licensing checks and may periodically report health, routes, and content availability to a central node, such as a device in or on the edge of a core network. Accordingly, the host 1100 may select and/or indicate a different host for over-the-top services for a UE. The host application programs 1114 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

Notably, modifications and other embodiments of the present disclosure will come to mind to one skilled in the art having the benefit of the teachings presented in the foregoing descriptions and the associated drawings. Therefore, it is to be understood that the present disclosure is not to be limited to the specific embodiments disclosed and that modifications and other embodiments are intended to be included within the scope of this disclosure. Although specific terms may be employed herein, they are used in a generic and descriptive sense only and not for purposes of limitation.

1.-28. (canceled)

29. A method performed by a domain name system (DNS) server in a communication network for facilitating silent multi-factor authentication of a user of an application, the method comprising:
receiving, from a communication device on which the application executes, a DNS query requesting the DNS server to resolve a domain name that is generic for some second factor server of some communication network;
resolving the domain name into an address of a second factor server in the communication network that is configured to generate a second factor for authenticating the user of the application; and
transmitting, to the communication device, a DNS response that indicates the address of the second factor server in the communication network.

30. The method of claim 29, wherein the second factor is a token, and wherein
the second factor server in the communication network is a token server; or
the second factor is a one-time passcode, and the second factor server in the communication network is a passcode server.

31. The method of claim 29, wherein the second factor server is configured to use subscription credentials based on which the communication device accesses the communication network to generate the second factor for authenticating the user of the application.

32. A method performed by a second factor server in a communication network for facilitating silent multi-factor authentication of a user of an application, the method comprising:
receiving, from a communication device on which the application executes, a request for a second factor for authenticating the user of the application;
responsive to the request, generating the second factor using subscription credentials based on which the communication device accesses the communication network, wherein the second factor is generated to be specific to a connection or session established based on the subscription credentials; and
transmitting the second factor to the communication device in response to the request.

33. The method of claim 32, wherein the second factor is generated to include one or more pointers, including:
a network pointer comprising a pointer to the communication network; and/or
an aggregator pointer comprising a pointer to an aggregator via which the second factor is verifiable.

34. The method of claim 32, wherein either:
the second factor is a token, and the second factor server in the communication network is a token server; or
the second factor is a one-time passcode, and the second factor server in the communication network is a passcode server.

35. The method of claim 32, wherein the subscription credentials include:
a Mobile Station International Subscriber Directory Number (MSISDN); or
an International Mobile Subscriber Identity (IMSI); or
a Subscription Permanent Identifier (SUPI); or
Generic Public Subscription Identifier (GPSI).

36. The method of claim 32, wherein the method further comprises obtaining the subscription credentials based on an Internet Protocol (IP) address of the communication device.

37. The method of claim 32, wherein the second factor is generated also to identify, or be specific to, the communication network as generator and/or verifier of the second factor.

38. The method of claim 32, further comprising:
receiving, from aggregator equipment, a request to verify a presented second factor, wherein the request includes the presented second factor and subscription information associated with a subscription to the communication network;
determining whether or not the presented second factor is verified by determining whether or not the presented second factor matches a second factor previously generated by the communication network for the subscription information included in the request; and
transmitting, to the aggregator equipment, a response indicating whether or not the second factor is verified according to said determining.

39. A method performed by aggregator equipment for facilitating silent multi-factor authentication of a user of an application, the method comprising:
receiving, from an application server for the application, a request to verify a second factor for authenticating the user of the application, wherein the request includes the second factor and subscription information associated with a subscription of the user to a communication network;
identifying, from the second factor or from the subscription information, a communication network that is generator and/or verifier of the second factor;
performing a verification procedure with the identified communication network, using the second factor and the subscription information included in the request, in an attempt to verify the second factor as authenticating the user of the application; and
transmitting a response to the request indicating whether or not the second factor is verified.

40. The method of claim 39, wherein performing the verification procedure comprises:
transmitting a verification request to the identified communication network that includes the second factor and the subscription information and that requests the identified communication network to verify the second factor, and receiving in response a verification result indicating whether or not the second factor is verified; or
transmitting a verification information request to the identified communication network that includes the subscription information and that requests the identified communication network to return a comparison second factor against which the second factor is verifiable, receiving the comparison second factor in response, and determining whether or not the second factor is verified by comparing the second factor with the comparison second factor.

41. The method of claim 39, wherein performing the verification procedure with the identified communication network comprises performing the verification procedure with a second factor server in the identified communication network.

42. The method of claim 39, wherein said identifying comprises retrieving a network pointer from the second factor, wherein the network pointer comprises a pointer to the communication network.

43. The method of claim 39, wherein the second factor is a token or a one-time passcode.

44. A method for silent multi-factor authentication of a user of an application, the method comprising:
transmitting, by a communication device on which the application executes, a first factor for authenticating the user of the application to an application server for the application;
receiving, at the communication device, from the application server, a domain name to which the communication device is redirected for obtaining a second factor for authenticating the user of the application to the application server, wherein the domain name is generic for some second factor server of some communication network;
transmitting, by the communication device, to a domain name system (DNS) server of a communication network to which the communication device has subscription credentials, a DNS query requesting the DNS server to resolve the domain name;
receiving, by the communication device, a response to the DNS query indicating an address of a second factor server in the communication network;
transmitting, by the communication device, to the address of the second factor server in the communication network, a request for a second factor for authenticating the user of the application;
responsive to the request, generating, by the second factor server, the second factor using subscription credentials based on which the communication device accesses the communication network, wherein the second factor is generated to be specific to a connection or session established based on the subscription credentials;
transmitting the second factor from the second factor server to the communication device in response to the request;
transmitting the second factor from the communication device to the application server for authenticating the user of the application to the application server;
receiving, at aggregator equipment, from the application server, a request to verify the second factor, wherein the request includes the second factor and subscription information associated with a subscription of the user to the communication network;
identifying, by the aggregator equipment, from the second factor or the subscription information, the communication network as generator and/or verifier of the second factor;
performing, by the aggregator equipment, a verification procedure with the communication network, using the second factor and the subscription information included in the request, in an attempt to verify the second factor as authenticating the user of the application; and
transmitting a response to the request from the application server indicating whether or not the second factor is verified.
